(19) United States
(12) Patent Application Publication
(10) Pub. No.: US 2016/0084567 A1
(43) Pub. Date: Mar. 24, 2016

(54) ANCHOR ASSEMBLIES AND MOUNTING KITS FOR CONNECTING DOOR HANDLES TO DOORS OF REFRIGERATOR APPLIANCES

(71) Applicant: General Electric Company, Schenectady, NY (US)

(72) Inventors: Ronald Fernandez, Louisville, KY (US); Anil Challapalli, Louisville, KY (US); Rambabu Koppineni, Bloomington, IN (US)

(21) Appl. No.: 14/492,257

(22) Filed: Sep. 22, 2014

(51) Int. Cl. F25D 23/02; F25D 31/00; E05B 1/00

(52) U.S. Cl. CPC F25D 23/028; E05B 1/00; F25D 31/00

(57) ABSTRACT

Anchor assemblies and mounting kits for connecting door handles to refrigerator door are provided. An anchor assembly includes an anchor. The anchor includes a base panel having a first face surface, an opposing second face surface, and an edge surface extending therebetween. The anchor further includes a collar extending from the first face surface of the base panel, the collar having an outer face surface spaced from the first face surface of the base panel and a side surface extending between the outer face surface and the first face surface of the base panel. The anchor further includes a head extending from the collar, the head having an outer face surface spaced from the outer face surface of the collar and a side surface extending between the outer face surfaces of the head and collar. The base panel, collar and head are integral with each other.

### FIELD OF THE INVENTION

The present subject matter relates generally to refrigerator appliances, and more particularly to anchor assemblies and mounting kits for connecting handles to the doors of refrigerator appliances.

### BACKGROUND OF THE INVENTION

Refrigerator appliances generally include a cabinet that defines a chilled chamber for receipt of food items for storage. In particular, the cabinet can define a fresh food chamber and a freezer chamber. The fresh food chamber can be maintained at a temperature greater than the freezing point of water. Conversely, the freezer chamber can be maintained at a temperature equal to or less than the freezing point of water.

Refrigerator assemblies further include doors which open to provide access to the fresh food chamber and/or freezer chamber. Each door generally includes a handle which a user can pull on to open the door and push on to close the door.

Presently known apparatus for connecting a handle to a door when assembling a refrigerator appliance require a substantial amount of labor and a substantial number of mounting components. This leads to higher refrigerator appliance costs, due to the costs associated with such labor and parts. Further, the risk of damaging of the door when, for example, driving various mounting components together is relatively high. One specific issue is that a number of the currently utilized components must be assembled to each other to form the anchor that the handle is mounted to in order to connect the handle to the door.

Accordingly, improved apparatus for connecting door handles to refrigerator doors, such as fresh food doors and/or freezer door, are desired. Specifically, apparatus that reduce the number of parts and associated labor costs and material costs, and that reduce the potential for damaging the door during assembly, would be advantageous.

### BRIEF DESCRIPTION OF THE INVENTION

Aspects and advantages of the invention will be set forth in part in the following description, or may be apparent from the description, or may be learned through practice of the invention.

In accordance with one embodiment, an anchor assembly for connecting a door handle to a refrigerator door is provided. The anchor assembly includes an anchor. The anchor includes a base panel having a first face surface, an opposing second face surface, and an edge surface extending between the first face surface and the second face surface. The anchor further includes a collar extending from the first face surface of the base panel, the collar having an outer face surface spaced from the first face surface of the base panel and a side surface extending between the outer face surface and the first face surface of the base panel. The anchor further includes a head extending from the collar, the head having an outer face surface spaced from the outer face surface of the collar and a side surface extending between the outer face surface of the head and the outer face surface of the collar. The base panel, collar and head are integral with each other.

In accordance with another embodiment, a mounting kit for connecting a door handle to a refrigerator door is provided. The mounting kit includes an end cap assembly, the end cap assembly including a housing that defines an anchor passage extending therethrough. The mounting kit further includes an anchor assembly connectable to the end cap assembly. The anchor assembly includes an anchor. The anchor includes a base panel having a first face surface, an opposing second face surface, and an edge surface extending between the first face surface and the second face surface. The anchor further includes a collar extending from the first face surface of the base panel, the collar having an outer face surface spaced from the first face surface of the base panel and a side surface extending between the outer face surface and the first face surface of the base panel. The anchor further includes a head extending from the collar, the head having an outer face surface spaced from the outer face surface of the collar and a side surface extending between the outer face surface of the head and the outer face surface of the collar. The base panel, collar and head are integral with each other.

In accordance with another embodiment of the present disclosure, a refrigerator appliance is provided. The refrigerator appliance includes a cabinet defining a fresh food chamber and a freezer chamber, and a door for accessing one of the fresh food chamber or the freezer chamber. The door includes an inner surface and an outer surface that define an interior therebetween, the outer surface further defining a mounting aperture extending therethrough. The refrigerator appliance further includes an anchor assembly, the anchor assembly including an anchor. The anchor includes a base panel having a first face surface, an opposing second face surface, and an edge surface extending between the first face surface and the second face surface. The base panel is disposed within the interior of the door. The anchor further includes a collar extending from the first face surface of the base panel, the collar having an outer face surface spaced from the first face surface of the base panel and a side surface extending between the outer face surface and the first face surface of the base panel. The collar extends through the mounting aperture. The anchor further includes a head extending from the collar, the head having an outer face surface spaced from the outer face surface of the collar and a side surface extending between the outer face surface of the head and the outer face surface of the collar. The base panel, collar and head are integral with each other.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front, elevation view of a refrigerator appliance with doors in closed positions in accordance with one embodiment of the present disclosure;

FIG. 2 provides an exploded perspective view of a door handle and two end cap assemblies utilized to mount the door handle to a door of a refrigerator appliance in accordance with one embodiment of the present disclosure;

FIG. 3 provides an exploded perspective view of an anchor assembly utilized to mount a door handle to a door of a refrigerator appliance in accordance with one embodiment of the present disclosure;

FIG. 4 is an exploded cross-sectional view of an anchor assembly utilized to mount a door handle to a door of a refrigerator appliance in accordance with one embodiment of the present disclosure; and

FIG. 5 is a perspective cross-sectional view of an anchor assembly and end cap mounted to a door of a refrigerator appliance in accordance with one embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

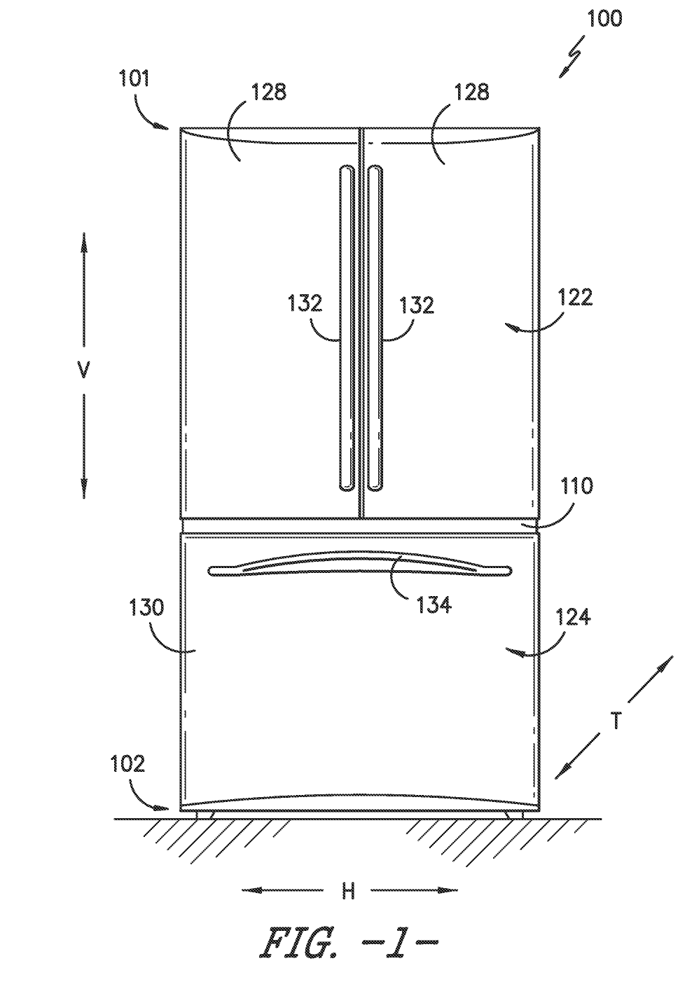

FIG. 1 provides a front, elevation view of a refrigerator appliance 100 according to an exemplary embodiment of the present subject matter with fresh food doors 128 and a freezer door 130 of the refrigerator appliance 100 shown in a closed position. Refrigerator appliance 100 includes a cabinet or housing 110 that extends between a top portion 101 and a bottom portion 102 along a vertical direction V. Cabinet 110 defines chilled chambers for receipt of food items for storage. In particular, cabinet 110 defines fresh food chamber 122 positioned at or adjacent top portion 101 of cabinet 110 and a freezer chamber 124 arranged at or adjacent bottom portion 102 of cabinet 110. Fresh food chamber 122 is thus in these embodiments disposed above freezer chamber 124 along the vertical direction V. As such, refrigerator appliance 100 is generally referred to as a bottom mount refrigerator appliance. It is recognized, however, that the benefits of the present disclosure apply to other types and styles of refrigerator appliances such as, e.g., a top mount refrigerator appliance or a side-by-side style refrigerator appliance. Consequently, the description set forth herein is for illustrative purposes only and is not intended to be limiting in any aspect to any particular refrigerator chamber configuration.

Horizontal and vertical directions H, T may additionally be defined by the refrigerator appliance. The vertical, horizontal and transverse directions V, H, T may each be perpendicular to each other.

One or more doors may be utilized to provide access to the various chambers of the appliance 100. For example, as illustrated, fresh food doors 128 are rotatably mounted or hinged to an edge of cabinet 110 for selectively accessing fresh food chamber 122. In addition, one or more freezer doors 130 are arranged below refrigerator doors 128 for selectively accessing freezer chamber 124. Freezer door 130 is coupled to a freezer drawer (not shown) slidably mounted within freezer chamber 124.

Door handles may be connected to the doors of a refrigerator appliance 100 to facilitate opening and closing of the associated doors. For example, a fresh food door handle 132 may be connected to each fresh food door 128, and a freezer door handle 134 may be connected to the freezer door 130, as illustrated.

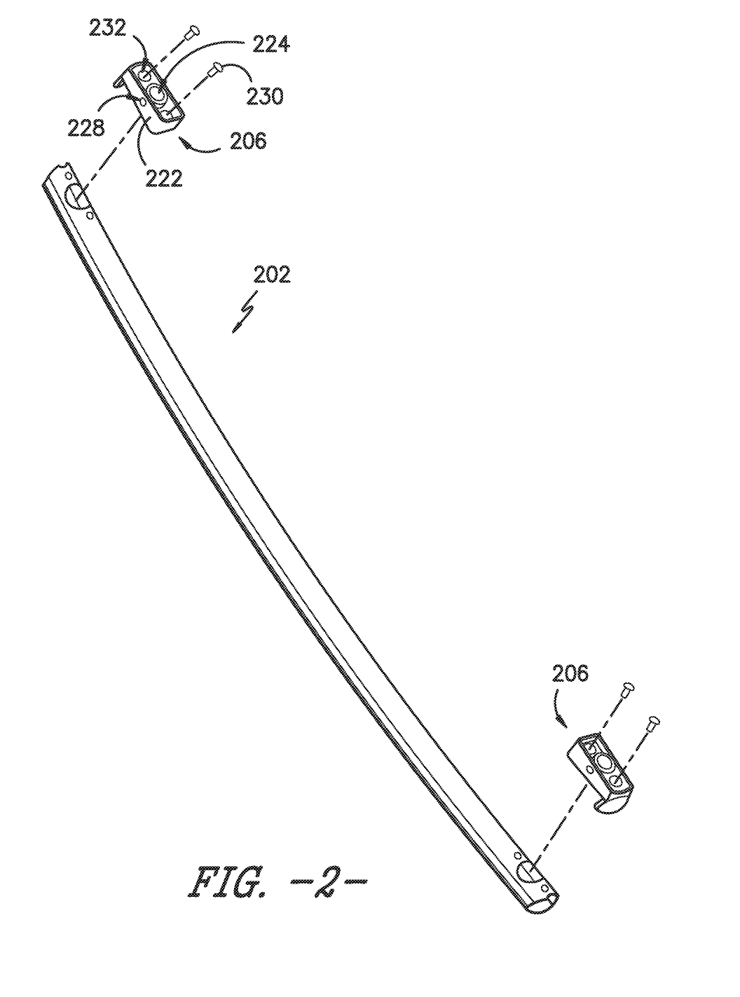

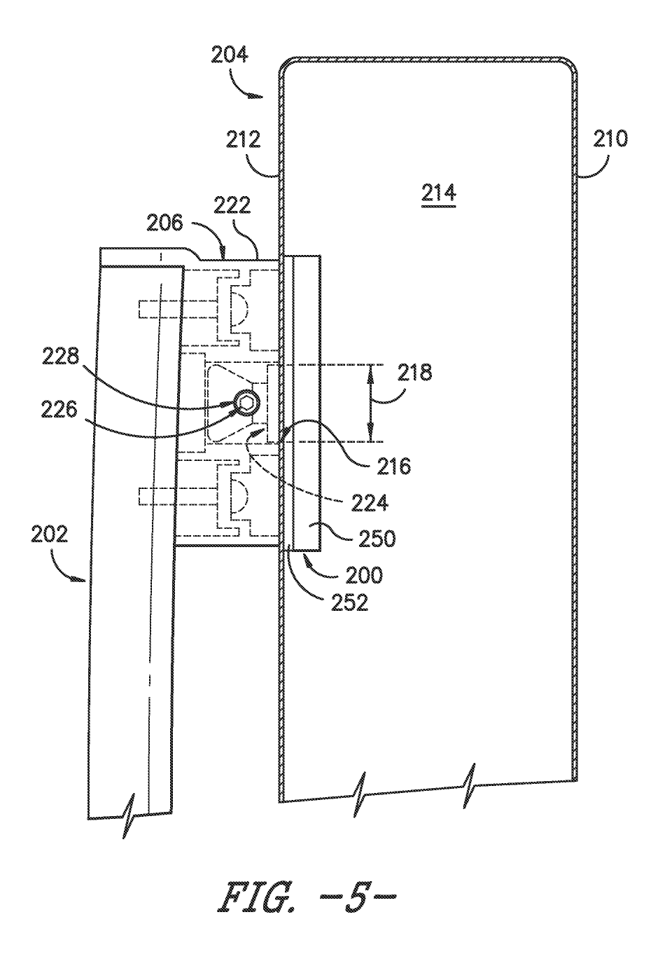

Referring now to FIGS. 2 through 5, improved anchor assemblies 200 are provided for connecting door handles 202 (such as fresh food door handles 132 or freezer door handles 134) to associated doors 204 (such as fresh food doors 128 or freezer doors 130). Advantageously, the anchor component of an anchor assembly, as discussed herein, is a single integral component that extends through the associated door 204 to connect the door handle 202 and door together. A head of an anchor may extend through and be mounted to an end cap assembly 206, for example, which may in turn be mounted to a door handle 202, thus connecting the door handle 202 to an associated door 204 that the anchor is mounted to. The integral, single-piece design of the anchor advantageously reduces the number of parts and associated labor required for connection of a door handle 202 to a door 204, and further reduces the risk of damage to the door 204 by eliminating the need to drive or otherwise couple various separate components together to form an anchor.

Referring briefly to FIG. 5, a door 204 in accordance with the present disclosure includes an inner surface 210 and an outer surface 212. The inner surface 210 and outer surface 212 may define an interior 214 therebetween. Additionally, outer surface 212 may define a mounting aperture 216. Mounting aperture 216 extends through the outer surface 212, and a portion of the anchor may extend through the mounting aperture 216 to connect the door handle 202 to the door 204 as discussed herein. A width 218 of the mounting aperture 216 is denoted in FIG. 5. In exemplary embodiments, mounting aperture 216 may have a circular cross-sectional. Alternatively, however, any suitable cross-sectional shape is within the scope and spirit of the present disclosure.

Referring now briefly to FIG. 2, as well as to FIG. 5, one or more end cap assemblies 206 may be utilized to couple an anchor of anchor assembly 200 to a handle 202, thus connecting the handle 202 to the door 204. For example, as illustrated, two end cap assemblies 206 may be utilized with a door handle 202 to connect the handle 202 to the door 204. An anchor assembly 200 may be utilized with each end cap assembly 206. An end cap assembly 206 may generally include a housing 222 that defines an anchor passage 224 extending therethrough. As discussed herein, a head of an anchor of an anchor assembly 200 may extend into the anchor passage 224 when the anchor and end cap assembly 206 are coupled together. End cap assembly 206 may further include, for example, a set screw 226, and the housing 222 may additionally define a set screw passage 228 extending therethrough. The set screw passage 228 may, for example, be generally transverse to the anchor passage 224, and may be in communication with the anchor passage 224 such that the set screw 226 may extend through the set screw passage 228 into the anchor passage 224. In exemplary embodiments, when the head of the anchor is disposed within the anchor passage 224, set screw 226 may be extending through the set screw passage 228 into the anchor passage 224 such that it contacts the head, generally coupling the end cap assembly 206 and anchor assembly 200 together. Mechanical fasteners 230, such as screws, nails, rivets, nut/bolt combinations, etc., may extend through attachment bores 232 further defined in the housing 222 and into the door handle 202, such that the end cap assembly 206 is also coupled to the handle 202. Since the anchor assembly 200 may additionally be coupled to the door 204, the coupling of the anchor assembly 200 and end cap assembly 206 may connect the door handle 202 and door 204. One or more anchor assemblies 200 and one or more end cap assemblies 206, optionally along with a door handle 202, may together be referred to as a mounting kit.

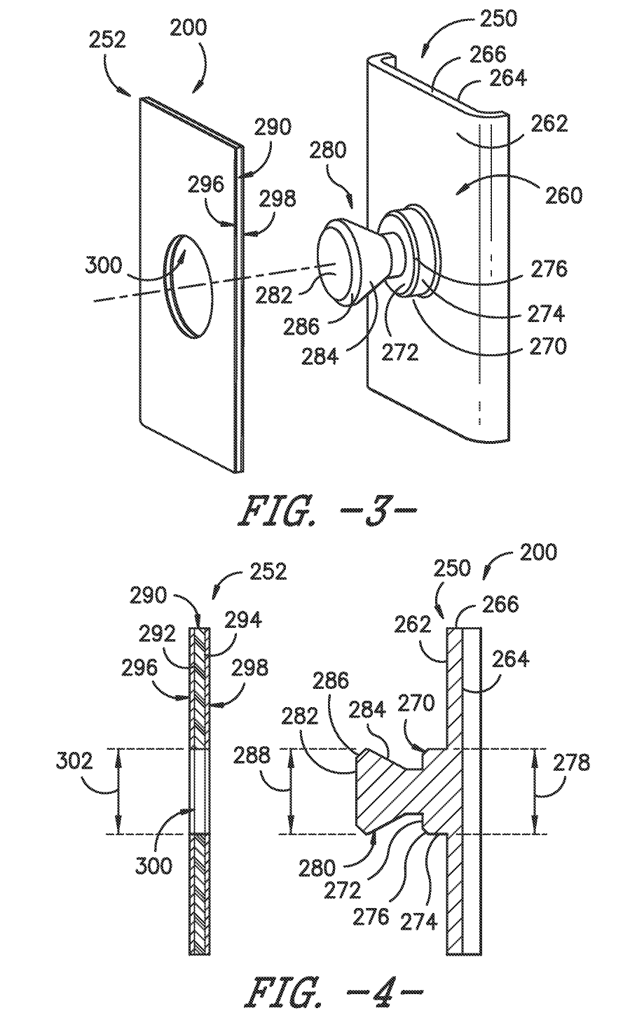

FIGS. 3-5 illustrate embodiments of an anchor assembly 200 in accordance with the present disclosure. Anchor assembly 200 includes an anchor 250, and may further include a gasket 252. Anchor 200 may include, for example, a base panel 260. The base panel 260 may include a first face surface 262 and an opposing second face surface 264. An edge surface 266 may extend between and separate the first face surface 262 and second face surface 264. In exemplary embodiments, at least a portion of the first face surface 262 is planer. For example, as shown, a central portion of the first face surface 262 is planer, and side portions are curviplaner.

Anchor 200 may further include, for example, a collar 270 extending from the first face surface 262 of the base panel 260, such as from the central portion thereof. The collar 270 may include an outer face surface 272 and a side surface 274. The outer face surface 272 may be spaced from the first face surface 262 of the base panel 260, and the side surface 274 may extend between the outer face surface 272 and the first face surface 262. In some embodiments, as illustrated, collar 270 may further include a chamfer surface 276, which may extend between the outer face surface 272 and the side surface 274.

In exemplary embodiments, the collar 270 is generally cylindrical, as illustrated. Accordingly, outer face surface 272 may be generally circular. Alternatively, however, collar 270 may be an oval cylinder, or may have any other suitable shape. Collar 270 may further have a width (or diameter) 278, as illustrated.

Anchor 200 may still further include, for example, a head 280 extending from the collar 270. The head 280 may include an outer face surface 282 and a side surface 284. The outer face surface 282 may be spaced from the outer face surface 272 of the collar 270, and the side surface 284 may extend between the outer face surface 282 and the outer face surface 272. In some embodiments, as illustrated, head 280 may further include a chamfer surface 286, which may extend between the outer face surface 282 and the side surface 284.

In exemplary embodiments, at least a portion of the head 280 is generally conical, as illustrated. Accordingly, outer face surface 282 may be generally circular, and at least a portion of side surface 284 may generally taper. For example, as illustrated, at least a portion of side surface 284 may in exemplary embodiments taper towards the collar 270. Alternatively, however, head 280 may have any other suitable shape.

Head 280 may further have a width (or diameter) 288, as illustrated. In exemplary embodiments as shown, a maximum width 288 of the head may be less than or equal to a maximum width 278 of the collar 270.

As shown, the base panel 260, collar 270 and head 280 are integral with each other, and thus formed from a single component. In exemplary embodiments, the anchor 250, and thus the integral base panel 260, collar 270 and head 280 thereof, is formed from steel or another suitable metal. Alternatively, however, anchor 250 may be formed from any suitable material.

As mentioned, in some embodiments, anchor assembly 200 may further include a gasket 252. Gasket 252 may include, for example, a pliable layer 290 comprising a first face surface 292 and an opposing second face surface 294. In exemplary embodiments, the pliable layer 290 may be formed from a polyethylene foam, although other suitable foams and other pliable materials are within the scope and spirit of the present disclosure. Gasket 252 may further include one or more adhesive layers, such as a first adhesive layer 296 which is applied to the first face surface 292 and a second adhesive layer 298 which is applied to the second face surface 294. In exemplary embodiments, an adhesive layer such as first and second adhesive layers 296, 298 may be formed from a pressure sensitive rubber adhesive. Alternatively, however, other suitable adhesives are within the scope and spirit of the present disclosure.

Gasket 252 may additionally define an aperture 300 therethrough. The aperture 299 may extend through each layer of the gasket 252, such as the pliable layer 290 and the adhesive layers 296, 298. Aperture 300 may further define a width 302, as shown.

To connect a door handle 202 and door 204, the anchor assembly 200 may be coupled to door 204 as well as to end cap 206. For example, the anchor 250 may be initially placed in the interior 214, and the head 280 and collar 270 placed through the mounting aperture 216. Accordingly, when coupled to the door 204, the head 280 may be external to the door 204, the collar 270 may extend through the mounting aperture 216, and the base panel 260 may be disposed within the interior 214. The gasket 252 may additionally be placed in the interior 214, such as between the base panel 260 and the outer surface 212. Accordingly, the collar 270 may additionally extend through aperture 300. The gasket 252 in exemplary embodiments may adhere to the outer surface 212 and the base panel 260, such coupling the anchor assembly 200 to the door 204.

In exemplary embodiments, a maximum width 278 of the collar 270 may be approximately equal to a maximum width 218 of the mounting aperture 216. Further, the cross-sectional shape and area of the collar 270 may in exemplary embodiments be approximately identical to the cross-sectional shape and area of the collar 270. Accordingly, when the collar 270 is extending through the mounting aperture 216, the collar 270 may substantially plug the aperture 216 and reduce or prevent leakage therethrough.

Additionally, in some embodiments, a maximum width 278 of the collar 270 may be approximately equal to a maximum width 302 of the aperture 300. Further, the cross-sectional shape and area of the collar 270 may in exemplary embodiments be approximately identical to the cross-sectional shape and area of the aperture 300. Accordingly, when the gasket 290 is adhered between and connecting the anchor 250 and outer surface 212, the collar 270 may further substantially plug the aperture 300 and reduce or prevent leakage therethrough.

Once anchor assembly 200 is coupled to the door 204, end cap 206 may be coupled to the anchor assembly 200 by, for example, placing the head 280 into the anchor passage 224 and inserting the set screw 226 as discussed above. The end cap 206 may further be coupled to the door handle 202, as discussed above. Accordingly, such coupling may result in efficient and cost-effective connection of the door handle 202 to the door 204.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. An anchor assembly for connecting a door handle to a refrigerator door, the anchor assembly comprising:
an anchor, the anchor comprising:
a base panel comprising a first face surface, an opposing second face surface, and an edge surface extending between the first face surface and the second face surface;
a collar extending from the first face surface of the base panel, the collar comprising an outer face surface spaced from the first face surface of the base panel and a side surface extending between the outer face surface and the first face surface of the base panel; and
a head extending from the collar, the head comprising an outer face surface spaced from the outer face surface of the collar and a side surface extending between the outer face surface of the head and the outer face surface of the collar,
wherein the base panel, collar and head are integral with each other.

2. The anchor assembly of claim 1, wherein at least a portion of the side surface of the head tapers towards the collar.

3. The anchor assembly of claim 1, wherein the head further comprises a chamfer surface extending between the outer face surface of the head and the side surface of the head.

4. The anchor assembly of claim 1, wherein the collar further comprises a chamfer surface extending between the outer face surface of the collar and the side surface of the collar.

5. The anchor assembly of claim 1, wherein the collar is generally cylindrical.

6. The anchor assembly of claim 1, wherein at least a portion of the head is generally conical.

7. The anchor assembly of claim 1, wherein a maximum width of the head is less than or equal to a maximum width of the collar.

8. The anchor assembly of claim 1, further comprising a gasket, the gasket comprising:
a pliable layer comprising a first face surface and an opposing second face surface;
a first adhesive layer applied to the first face surface; and
a second adhesive layer applied to the second face surface.

9. The anchor assembly of claim 8, wherein the pliable layer is formed from a polyethylene foam.

10. The anchor assembly of claim 8, wherein the first adhesive layer and the second adhesive layer are each formed from a pressure sensitive rubber adhesive.

11. A mounting kit for connecting a door handle to a refrigerator door, the mounting kit comprising:
an end cap assembly, the end cap assembly comprising a housing that defines an anchor passage extending therethrough; and
an anchor assembly connectable to the end cap assembly, the anchor assembly comprising an anchor, the anchor comprising:
a base panel comprising a first face surface, an opposing second face surface, and an edge surface extending between the first face surface and the second face surface;
a collar extending from the first face surface of the base panel, the collar comprising an outer face surface spaced from the first face surface of the base panel and a side surface extending between the outer face surface and the first face surface of the base panel; and
a head extending from the collar, the head comprising an outer face surface spaced from the outer face surface of the collar and a side surface extending between the outer face surface of the head and the outer face surface of the collar,
wherein the base panel, collar and head are integral with each other.

12. The mounting kit of claim 11, wherein the end cap assembly further comprises a set screw and the housing further defines a set screw passage extending therethrough generally transverse to the anchor passage.

13. The mounting kit of claim 11, wherein the anchor assembly further comprises a gasket, the gasket comprising:
a pliable layer comprising a first face surface and an opposing second face surface;
a first adhesive layer applied to the first face surface; and
a second adhesive layer applied to the second face surface.

14. A refrigerator appliance, comprising:
a cabinet defining a fresh food chamber and a freezer chamber;
a door for accessing one of the fresh food chamber or the freezer chamber, the door comprising an inner surface and an outer surface that define an interior therebetween, the outer surface further defining a mounting aperture extending therethrough; and
an anchor assembly, the anchor assembly comprising an anchor, the anchor comprising:
a base panel comprising a first face surface, an opposing second face surface, and an edge surface extending between the first face surface and the second face surface, the base panel disposed within the interior of the door;
a collar extending from the first face surface of the base panel, the collar comprising an outer face surface spaced from the first face surface of the base panel and a side surface extending between the outer face surface and the first face surface of the base panel, the collar extending through the mounting aperature; and
a head extending from the collar, the head comprising an outer face surface spaced from the outer face surface of the collar and a side surface extending between the outer face surface of the head and the outer face surface of the collar,
wherein the base panel, collar and head are integral with each other.

15. The refrigerator appliance of claim 14, wherein at least a portion of the side surface of the head tapers towards the collar.

16. The refrigerator appliance of claim 14, wherein the collar is generally cylindrical.

17. The refrigerator appliance of claim 14, wherein at least a portion of the head is generally conical.

18. The refrigerator appliance of claim 14, wherein a maximum width of the head is less than or equal to a maximum width of the collar.

19. The refrigerator appliance of claim 14, wherein a maximum width of the collar is approximately equal to a maximum width of the mounting aperture.

20. The refrigerator appliance of claim 14, wherein the anchor assembly further comprises a gasket, the gasket comprising:
a pliable layer comprising a first face surface and an opposing second face surface;
a first adhesive layer applied to the first face surface; and
a second adhesive layer applied to the second face surface.
